(19) United States
(12) Patent Application Publication
(10) Pub. No.: US 2009/0225309 A1
(43) Pub. Date: Sep. 10, 2009

(54) TIME-LAPSE ANALYSIS CHAMBER FOR LASER CAPTURE MICRODISSECTION APPLICATIONS

(76) Inventor: Zoe N. Demou, Chicago, IL (US)

Correspondence Address: BRINKS HOFER GILSON & LIONE, P.O. BOX 10395, CHICAGO, IL, 60610, US

(21) Appl. No.: 12/392,274

(22) Filed: Feb. 25, 2009

Related U.S. Application Data
(60) Provisional application No. 61/033,523, filed on Mar. 4, 2008.

(51) Int. Cl. G01N 21/01

(52) U.S. Cl. 356/246

(57) ABSTRACT

Devices, systems, and methods for the monitoring and morphological characterization of 3D cell cultures targeted for laser capture microdissection (LCM) are provided. The devices, systems and methods presented herein provide a discovery engine for probing cellular plasticity and differentiation in 3D cultures with genomics and proteomics.

### CROSS-REFERENCE TO RELATED APPLICATIONS

This invention claims priority to U.S. Provisional Patent Application Ser. No. 61/033,523 filed on Mar. 4, 2008, which is incorporated herein by reference.

### FIELD OF THE INVENTION

The present invention relates generally to devices and methods for the monitoring and morphological characterizations of cell cultures targeted for laser capture microdissection (LCM). More particularly, the present invention provides a time-lapse analysis chamber that is suitable for LCM applications.

### BACKGROUND

Laser Capture Microdissection (LCM) is a method for isolating pure cells of interest from specific microscopic regions of tissue sections. Typically, a tissue section is applied on a transparent transfer film which may be either attached on a metallic frame or superimposed on a glass slide. Under a microscope, the thin tissue section is viewed and microscopic clusters of cells are selected for isolation. When the cells of choice are in the center of the field of view, the operator pushes a button that activates a near-infrared laser diode integral with the microscope optics. The pulsed laser beam activates a precise spot on the transfer film, fusing the film with the underlying cells of choice. The transfer film with the bonded cells is then lifted off the thin tissue section, leaving all unwanted cells behind. In addition a UV laser can cut the supporting membrane around the cells and facilitate their release from it while increasing the specificity of tissue isolation during lifting.

The laser capture microdissection process does not alter or damage the morphology and chemistry of the sample collected, nor the surrounding cells. For this reason, LCM is a useful method of collecting selected cells for molecular analyses, and can be performed on a variety of tissue samples including blood smears, cytologic preparations, cell cultures and aliquots of solid tissue. LCM has been traditionally performed on histological sections of fixed tissue explants (paraffin embedded or frozen) for a wide range of genomic and proteomic analyses including: DNA heterozygosity and methylation, gene expression (real-time PCR, microarrays) and protein assays, including Western blotting, two dimensional (2D) gel electrophoresis, protein microarrays, and mass spectrometry (Espina et al., 2007, Expert Rev. Mol. Diag. 7: 647-657; Murray, 2007, Acta Histochemica 109: 171-176). Laser capture microdissection is being increasingly utilized for isolating cell subpopulations during normal development and disease-states.

Traditionally, time-lapse imaging in bioengineering is combined with image analysis for measuring dynamic cellular features of interest and often for analyzing cellular motion. Motion tracking at the cellular level requires frequent image acquisition during long periods of time; therefore, extracting individual cell trajectories is best performed in specialized, dedicated systems equipped with environmental controls (Demou and McIntire, 2002, Cancer Res. 62: 5301-5307).

The term “vasculogenic” or “vascular mimicry” describes the formation of vascular-like structures by self-differentiating non-endothelial cells in vivo or in culture. The phenomenon was first identified in melanoma and subsequently in a plethora of other cancer types including sarcoma, inflammatory and ductal breast carcinoma, ovarian, and prostatic carcinoma. The etiology of vasculogenic mimicry remains unclear. It has been speculated that the cancer cells have a stem-cell-like potential and trans-differentiate into normal cell types. Furthermore, distinct phenotypes of practical interest can emerge under directed differentiation of stem cells. In general, approaches in the fields of tissue engineering and organ development capitalize on factor-induced cell differentiation and could benefit from methodologies that enable molecular analysis of the resulting cell sub-populations. Implementation of such analyses requires methods for monitoring the differentiating cells over time and the ability to specifically isolate the heterogeneous subpopulations at user-defined end-points for downstream molecular assays. The present invention provides devices and methods for achieving these and related objectives.

### BRIEF SUMMARY

In a first embodiment, chambers are provided, which include a base member which defines a recessed area dimensioned to receive a membrane frame slide. The base member defines a perimeter portion and further defines a transparent portion dimensioned for viewing biological material on the membrane frame slide. The chambers also include a lid member which is dimensioned to at least substantially overlay the base member when the lid member is closed. The lid member defines a perimeter portion and further defines a transparent portion dimensioned for viewing biological material on the membrane frame slide. The chambers are dimensioned so that the biological material can be imaged by time-lapse imaging. The chambers are configured so that the biological materials can be analyzed using laser capture microdissection means. The chambers may include one or more perimeter seals for facilitating the sealing between the base member and the lid member. The base member may define a slot extending outwardly from the recessed area, the slot substantially parallel to the membrane frame slide, where the slot is configured for releasably removing the membrane frame slide from the chamber, when the chamber is open. The transparent portion of the base member may include glass, and the perimeter portion of the base member may include stainless steel. The transparent portion of the lid member may include glass, and the perimeter portion of the lid member may include stainless steel. The chambers may include a lid member latch to fix the lid member in a closed position over the base member. The chambers may be designed for use in conjunction with a Veritas (Molecular Devices Corp.—MDS Inc., Mississauga, Ontario, Canada) laser capture microdissection system.

In a second embodiment, chambers are provided for holding specimen slides. The chambers include: a base member comprising a perimeter portion and a transparent portion, the base member sized to permit insertion of a specimen slide; and a lid member comprising a perimeter portion and a transparent portion, the lid member with a top and bottom surface, where the bottom surface overlays the specimen slide space in the chamber when the lid member is closed. The chamber is configured and dimensioned so that the specimen can be imaged by time-lapse imaging and analyzed using laser capture microdissection means. The chambers may include one or more seals for facilitating the sealing between the base member and the lid member. The chambers may include a base member that defines a slot extending outwardly from the specimen slide space, where the slot is substantially parallel to the specimen slide, and the slot is configured for releasably removing the specimen slide from the chamber, when the chamber is open. The transparent portion of the base member may be made of glass, and the perimeter portion of the base member may made of be stainless steel. The transparent portion of the lid member may be made of glass, and the perimeter portion of the lid member may be made of stainless steel. The chambers may include a lid member latch to fix the lid member in a closed position over the base member. The chambers may be designed for use in conjunction with a Veritas laser capture microdissection system.

In a third embodiment, systems are provided for the monitoring of specimen targeted for laser capture microdissection. These systems include: (a) a chamber for holding specimen slides, the chamber dimensioned so that the specimen can be imaged by time-lapse imaging and it can be analyzed using laser capture microdissection means, where the chamber includes a base member comprising a transparent portion, the base member sized to permit insertion of a specimen slide, and the chamber also includes a lid member comprising a transparent portion, the lid member with a top and bottom surface, where the bottom surface overlays the specimen slide space in the chamber housing when the lid member is closed; (b) an apparatus for laser capture microdissection suitable for use in conjunction with the chamber; and (c) software for automated time-lapse imaging of the specimen when the specimen is positioned in the chamber.

In a fourth embodiment, methods are provided for the monitoring of biological material targeted for laser capture microdissection. The methods include: (a) providing a chamber suitable for use in conjunction with a laser capture microdissection apparatus, where the chamber comprises a base member which defines a recessed area dimensioned to receive a membrane frame slide, the base member further defining a perimeter portion and a transparent portion dimensioned for viewing biological material on the membrane frame slide; and a lid member which is dimensioned to overlay the base member when the chamber is closed, the lid member further defining a perimeter portion and a transparent portion dimensioned for viewing biological material on the membrane frame slide; (b) imaging the specimen using time-lapse imaging means, and; c) subsequently analyzing the specimen using laser capture microdissection means. In the practice of the methods, the chamber may be designed for use in conjunction with a Veritas laser capture microdissection system.

### BRIEF DESCRIPTION OF THE DRAWINGS

FIG. 1 is an image of one embodiment of a device according to the present invention, shown as a custom-made chamber that houses an LCM-compatible metallic-membrane frame slide containing 3D cell culture targeted for time-lapse imaging and subsequent microdissection at an LCM platform.

FIG. 2 shows perspective views of two embodiments of a custom-made chamber in accordance with the present invention: (a) “cropped corner” design; (b) “full corner” design.

FIG. 3 shows: (a) top plan view; (b) bottom plan view; (c) one cross-sectional view, and (d) another cross-sectional view of a base member of a custom-made chamber in accordance with the present invention.

FIG. 4 shows: (a) top plan view; (b) bottom plan view; and (c) cross-sectional view of a lid member of a custom-made chamber in accordance with the present invention.

FIG. 5 shows images obtained using a device of the present invention, illustrating how MUM2B aggressive melanoma cells cultured on 3D collagen type-I gels spontaneously differentiate in vascular vessel-like structures.

FIG. 6 shows images obtained using a device of the present invention, illustrating time-lapse evolution of vasculogenic mimicry networks of MUM2B melanoma cells on collagen type-I gels (bright field optics).

FIG. 7 shows images obtained using a device of the present invention and drawings illustrating image analysis for quantification of the extent of vasculogenic mimicry in 3D cultures of melanoma cells.

FIG. 8 is a graph of the distribution of network coverage (area covered by vessel-like structures) per analyzed field of view (each 16.5 mm²) for early and mature states of vasculogenic mimicry.

FIG. 9 shows graphs illustrating: (A) boxplot of the distribution of network lengths for early and mature states of vasculogenic mimicry; (B) truncated scale of the distribution in panel (A) for better visualization of the median, 10th, 25th, 75th, 90th percentiles.

FIG. 10 is a graph of the distribution of estimated network widths for early and mature states of vasculogenic mimicry.

FIG. 11 shows graphs (A, B, C) and an image (D) demonstrating: typical bioanalyzer electropherograms for RNA samples purified from melanoma cells in laser capture microdissected networks (A) and nests (B) compared to control RNA (C); (D) the corresponding RNA gel-view for (A-C).

FIG. 12 shows images illustrating gene microarray profiling of 128 angiogenesis-specific genes in “mature” networks (A) and randomly oriented (nests) (B) of MUM2B melanoma cells.

FIG. 13 is a graph illustrating a real-time PCR array for profiling in parallel 96 angiogenesis-specific genes from microdissected “mature” MUM2B melanoma networks.

FIG. 14 shows images illustrating 2D gel electrophoresis results for MUM2B cells in microdissected “mature” networks (A) and nests (B).

FIG. 15 is a graph illustrating real-time PCR gene expression analysis for select genes in melanoma networks versus surrounding randomly oriented cells. The results show that levels of differential gene expression increase with the maturity of the networks.

### DETAILED DESCRIPTION OF THE PRESENTLY PREFERRED EMBODIMENTS

A device, which is a custom chamber for time-lapse analysis on LCM platforms, is provided. This device can be used to visualize, on a microscopic platform, any materials that change over time. These materials may be, e.g., biological materials. “Biological material” includes, but is not limited to, single and double-stranded oligonucleotides, DNA, RNA, proteins, protein fragments, peptides, aptamers, antibodies, antigens, lectins, carbohydrates, transcription factors, cellular components, cellular surface molecules, cells, cell cultures, tissues, combinations thereof, etc. The device is particularly well suited for observation over time of growing and/or developing cultures of cells, including stem cells, melanoma cells, etc. The observations may include observations over time of the changes in morphology, structure, anatomy, quantification of the observed materials, etc. In one embodiment, the custom-made chamber described here is aimed for time-lapse over a period of days or weeks preceding LCM. In some embodiments, the device is suitable for visualization and imaging of an entire frame slide platform, which can contain 2D or 3D cell cultures. The devices of the present invention enable pre-selection of targets in living 2D or 3D cell cultures to ultimately optimize quality of biomolecules for genomics and proteomics.

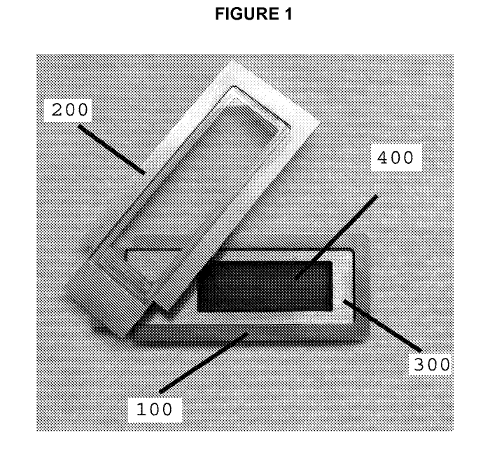

Exemplary embodiments of the device of the present invention are illustrated in FIGS. 1-4. The dimensions of the chambers for time-lapse analysis on LCM platforms according to the present invention may vary, therefore the chambers may be well suited for use on different LCM platforms, including but not limited to Zeiss (Carl Zeiss A G, Oberkochen, Germany), Leica (Leica Microsystems, Germany), and Veritas (Molecular Devices Corp.—MDS Inc., Mississauga, Ontario, Canada). In general, the chamber should be big enough to allow housing of the slide that is used for LCM on a particular LCM platform. For example, the chamber should be designed to accommodate a membrane frame slide or an equivalent type of support or substrate for growth of cells or tissues that are used for LCM applications. What is important is that, during image acquisition, the chamber is always positioned in a same position on a microscope stage or on other type of support suitable for time-lapse imaging.

A bioengineering system for studying the dynamics of in vitro cell differentiation is provided. The bioengineering system of the instant invention combines: (i) a chamber configured and dimensioned for imaging of a cell culture in 3D substrate; (ii) time-lapse monitoring and morphological characterization of a phenotypically evolving cell culture over-time; (iii) ability to specifically isolate with LCM distinct cell sub-populations; and optionally (iv) compatibility with genomics and/or proteomics, thereby enabling a range of analyses at the molecular level.

To take further advantage of the chamber, in preferred embodiments of the invention the imaging of the specimen is automated, e.g. with the help of software that performs automated image acquisition. For example, cell cultures, typically on culture slides, normally maintained in a cell culture incubator, can be placed in the chamber before imaging. The chamber is typically designed so that it offers an airtight seal to protect the culture from contamination and impermissible drying during imaging. Images of the live culture can be acquired at different magnifications at mosaic patterns following functions of the software and the built-in motorized stage of the system. The entire area of the slide (culture area and membrane frame) can be readily imaged while regions of interest (ROIs) can be revisited for time-lapse imaging by saving the coordinates of the regions of interest utilizing software functions. In addition, strategically positioned marks on the frame can facilitate image registration for time-lapse analysis.

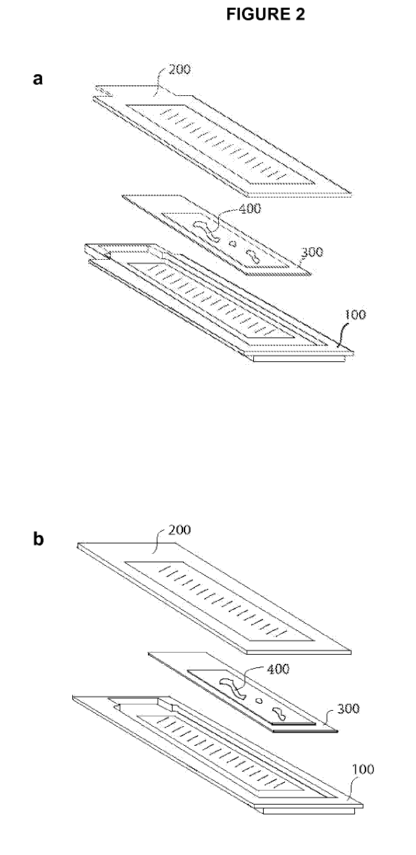

In accordance with the present invention, FIG. 1 shows an image, and FIG. 2 illustrates perspective views of two embodiments of a custom-made chamber according to the present invention, which houses an LCM compatible frame slide containing a three-dimensional cell culture targeted for time-lapse imaging and subsequent microdissection using an LCM platform. The chamber includes: a base member 100 (also referred to as “base”), and a lid member 200 (also referred to as “lid”). Also shown in FIGS. 1 and 2 is a membrane frame slide 300 (also referred to as a “specimen slide”), and containing examples of specimen, i.e. live culture 400. The live culture 400 may be overlaid with media (not shown). FIG. 2(a) is a view of a chamber with a “cropped corner” design, where the base member and/or the lid member may have one or more corners cropped (cut). FIG. 2(b) is a view of a chamber with a “full corner” design, where the base member and the lid member do not have any corners cropped (cut). This invention contemplates the use of chambers with and/or without cropped corners. The “cropped corner” chamber design has the advantage of being lighter (i.e. it has less weight) that the “full corner” chamber design. The full corner design may have the advantage of providing a better air-tight seal, and thus better protection against contamination, because it allows for larger contact area between the lid member and the base member.

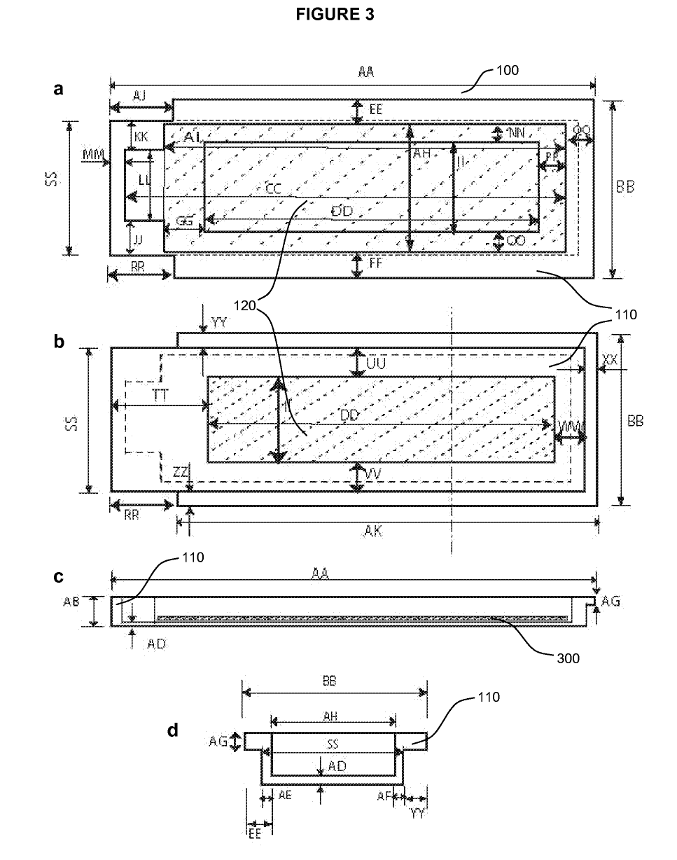

The base member 100 is generally a block having perimeter with side portions 110 and at least one transparent portion (area) 120 (FIG. 3). In one embodiment the base member 100 is generally rectangular, having an x-axis edges M and a y-axis edges BB (FIG. 3). The base member may have a desired thickness that is indicated as AB in FIG. 3. The transparent portion 120 may also be rectangular, e.g. with dimensions DD and II as shown in FIG. 3. One or more of the corners of the base member may be cut (cropped), to decrease the weight of the base member. For example, AJ and RR indicate areas of the base member that may be cropped. The base member is designed such that a membrane frame slide 300 (e.g. as shown rectangularly shaped with dimensions AH and AI) can be positioned onto the base member. The base member is dimensioned with a recessed area (specimen plate space), so that the membrane frame slide 300 can be fittingly positioned into the recessed area of the base member. The recessed area also includes empty space sufficient for accommodating the specimen in three dimensions, and for allowing air exchange and breathing of the specimen during the imaging steps. The recessed area of the base member has side portions with walls that have thickness of AE, AF, XX, and MM. By regulating the geometry of the base member, it is possible to regulate the volume of the air or other gas entrapped as a volume in the specimen plate space when the lid is in place (i.e. when the chamber is closed), and also the total weight of the chamber, and ensure optical compatibility with the LCM instrument of interest. For example, by decreasing the thickness of the side portions and/or increasing the height AB of the base member, the volume of air or other gas entrapped as a volume when the lid is in place can be decreased.

The base member 100 includes one or more transparent portions 120. The transparent portion may be affixed (e.g. glued) to the base member. The transparent portion enables viewing of the specimen inside the chamber. Examples of suitable transparent portion include glass, or transparent polymer such as polycarbonate, acrylic, etc. The perimeter (not necessarily transparent) material, i.e. the side portions of the base member, may be fabricated from a variety of materials, including one or more metals, metal alloys, Delrin or other plastic, combinations of one or more metals and plastic, etc. Generally, the base member is designed and manufactured so that it is capable of holding the shape when thin, and should be made of material that can be repeatedly sterilized and/or disposed.

It will be appreciated that although a particular geometry of the base member is shown, i.e. the base member is shown as substantially a block with rectangular cross-sections, other shapes and geometries are contemplated. The shapes and geometries selected should be suitable for use of the chamber in a desired LCM system. In general, the shapes and geometries selected should facilitate the efficient positioning of the chamber in automated equipment. One or more alignment marks, protrusions, tabs, lips, or other alignment means may be positioned along the base member, e.g. they may be centered along the x-axis and/or the y-axis of the base member, or they may be positioned on one or more of the edges of the base member. Alignment means may be used to facilitate the efficient positioning of the chamber in equipment for time-lapse imaging. For example, to precisely position the chamber, alignment tabs may be constructed at the base member, with a tolerance of about 0.1 mm. It will be appreciated that other tolerances can be used to precisely place the chamber on the imaging platform. In principle, precise positioning of the chamber permits automated time-lapse imaging using image recognition software. Optionally, the base member may have one or more gripper lips for cooperating with a robotic member.

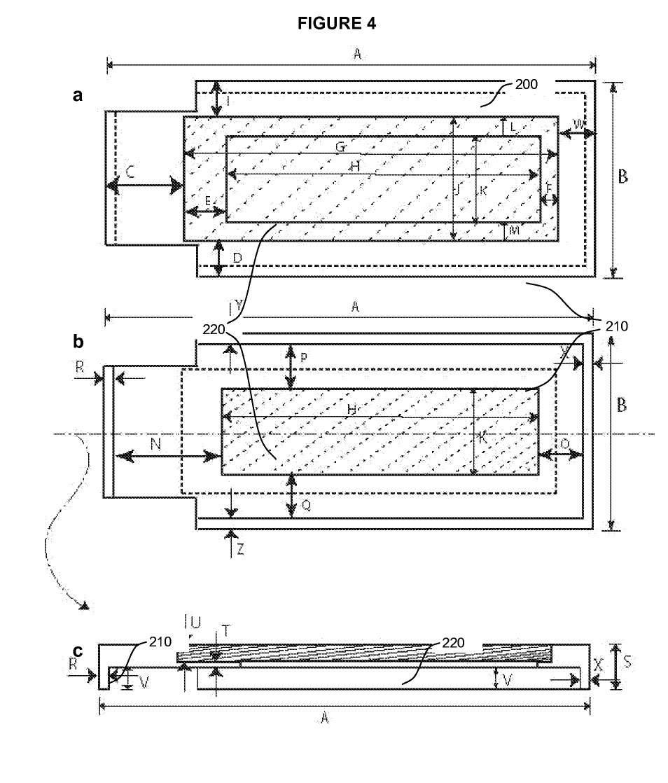

The lid member 200 is generally a block having a perimeter with side portions 210 and at least one transparent portion (area) 220 (FIG. 4). In one embodiment the lid member 200 is generally rectangular, having x-axis edges A and y-axis edges B (FIG. 4). The lid member may have a desired thickness that is indicated as S in FIG. 4. The thickness S shown in FIG. 4 also includes a ledge with a height V. In one embodiment, the ledge of the lid member is designed so that it fits around the perimeter of the base member, to generally provide an airtight fit. The transparent portion 220 may also be rectangular, e.g. with dimensions G and J as shown in FIG. 4. One or more of the corners of the lid member may be cut (cropped), to decrease the weight of the lid member. The lid member is designed such that a membrane frame slide 300 (e.g. rectangularly shaped with dimensions AH and AI) can be covered with the lid when the chamber is closed. In some preferred embodiments, the lid member may be dimensioned with a lid latch to fix the lid member in a closed position over the base member.

The lid member includes one or more transparent portions. The transparent portion may be affixed (e.g. glued) to the lid member. The transparent portion enables viewing of the specimen inside the chamber. Examples of material suitable for fabricating the transparent portion include glass, Delrin plastic, acrylic, etc. The perimeter (not necessarily transparent) material, i.e. the side portions of the lid member, may be fabricated from a variety of materials, including metals, plastic, combinations of one or more metals and other materials such as plastic. Generally, the lid member is designed and manufactured so that it is capable of holding the shape when thin, and should be made of material that can be sterilized and/or disposed.

It will be appreciated that although a particular geometry of the lid member is shown, i.e. the lid member is shown as substantially a block with rectangular cross-sections, other shapes and geometries are contemplated. The shapes and geometries selected should be suitable for use of the chamber in a desired LCM system. In general, the shapes and geometries selected should facilitate the efficient positioning of the chamber in automated equipment. One or more alignment marks, protrusions, tabs, lips, or other alignment means may be positioned along the lid member, e.g. they may be centered along the x-axis and/or the y-axis of the lid member, or they may be positioned on one or more of the edges of the lid member. For example, to precisely position the chamber, alignment tabs may be constructed at the lid member, with a tolerance of about 0.1 mm. It will be appreciated that other tolerances can be used to precisely place the chamber on the imaging platform.

The chamber is typically designed to offer an airtight seal to protect the culture from contamination when the culture is imaged on an LCM platform. This can be achieved in a variety of ways, e.g. by aligning the lid member with the base member, using ledges, latches, or seals. For example, tight fit between the base member and the lid member may be achieved by dimensioning one or both (lid and base) members with a latch to fix the lid member in a closed position over the base member. In some embodiments, the chamber may include a perimeter seal that surrounds the membrane frame slide. The seal can have a variety of shapes and forms, and in general is designed so that it offers an airtight seal to protect the culture (specimen) from contamination. For example, a rubber seal may be fittingly positioned between the lid member and the base member. It will be appreciated that methods such as adhering may be used to fix the seal onto the lid member or onto the base member. However, in some embodiments a frictional fit is preferred as the seal may be conveniently removed for placing and exchanging the cell culture samples, replacement of the sealant, cleaning, or sterilization of the chamber. The seal is preferably a rubber, and most preferably a silicon rubber. Silicon rubber, or another highly compliant (preferably biocompatible) material, is preferred as an efficient seal that can be created with a minimum compressive force. It may also be possible to sandwich a thin gasket (e.g. made of parafilm or other suitable material) between the base member and lid member parts of the chamber. The gasket may be attached to the lid member and/or the base member. Alternatively, or in addition, the gasket may be removable. For example, the gasket may be positioned on top of the base member ledge QQ; it may be permanently attached to the ledge, or it may be removably attached to the ledge. It will be appreciated that a variety of geometries and shapes can be used to provide a sufficient seal between the lid member and the base member. Further, the geometry and shape of the perimeter portion or other sealing area may direct modification in the seal shape and geometry.

In one aspect, the lid member is weighted so that when the lid member is aligned and positioned on the base member, the weight of the lid member provides a gravitational force to sufficiently compress the lid member against the upper surface on the base member. Accordingly, the lid member is sufficiently sealed to the base member to avoid contamination and impermissible drying. Therefore, the chambers may have lid members with a perimeter portion functioning as a compressibly sealing area.

In one embodiment, one or more cropped areas of the lid member and/or the base member are provided. While not essential for practicing the invention, these cropped areas make the chamber lighter, and they may be used for alignment and/or automated positioning and imaging of the chamber on the imaging platform.

In use, the specimen plate is placed in the recessed area of the base member, and the lid member is positioned so that it covers and sufficiently seals the specimen plate space. The lid member is designed so that it facilitates the gentle and efficient covering and uncovering of the specimen plate. When the lid member is fit onto the base member, the weight of the perimeter surface of the lid member acts as a sealing surface for compressibly sealing the perimeter surface of the lid member to the perimeter surface of the base member, thereby protecting the specimen plate in the recessed area against contamination. The volume of air that is located in the recessed area and above the specimen plate provides sufficient aeration of the specimen during imaging. Alignment tabs may be constructed to cooperate with the sidewalls of the chamber members and to guide the lid member to the base member for efficient sealing, while having sufficient spacing so that the tabs do not frictionally engage the sidewalls of the chamber members.

To cover the specimen once it is positioned in the recessed area of the base member, the lid member is lifted and positioned above the specimen plate space of the base member. It will be appreciated that the lifting and positioning may be performed manually or by a machine such as a robot. The lid member is generally aligned with the base member and lowered. As the lid member is lowered, the lid member ledges and/or any lid member alignment tabs begin to cooperate with the sidewalls on the base member, to accurately position the lid member as the lid member is lowered. In such a manner, the lid member can be only approximately positioned above the specimen plate space and as the lid member is lowered, the ledges and/or alignment tabs guide and align the lid member. Thereby, when the lid member is fully resting on the base member, the lid member is precisely positioned and aligned with the base member so that the specimen is visible through the transparent portions on the lid member and on the base member.

The chamber may be used as described for manual use. In such a manner, a technician or other operator manually grabs, aligns, and lowers the lid member over the base member containing the specimen plate. In a similar manner, the technician or user would remove the lid member. However, it may be desirable for some applications that the lid member be fitted and removed by an automatic system, such as a robotic system. To facilitate manipulation by an automatic robotic system, the chamber (lid and/or base member) can optionally include a gripper lip on the x-axis edges. It will be appreciated that other structures may be positioned on the lid member and/or base member for cooperating with a gripper mechanism on a robotic system.

The chamber can be manufactured from a variety of materials, including but not limited to stainless steel, titanium, aluminum, metal alloys, Delrin plastic, glass, acrylic, etc. In preferred embodiments, the chamber is capable of holding the shape when thin, and should be made of material that can be sterilized and/or disposed. For example, as shown in FIG. 1, the chamber can be manufactured from stainless steel and glass. In the embodiment shown in FIG. 1, the perimeter (not necessarily transparent) parts of both the chamber base member and the chamber lid member are made of stainless steel, and the transparent regions where the cells and/or tissue are being visualized are made out of glass. The glass is attached to the frame, e.g. using a desired type of glue. Thus the chamber provides an airtight seal to protect the culture from contamination during imaging. This type of stainless steel/glass chamber is readily sterilizable in a variety of ways, e.g. it is autoclavable.

Stainless steel is also a preferred material because of its superior machining characteristics. Due to the geometry and narrowness of the perimeter surfaces, it is important that the lid member be accurately positioned and aligned with the base member. By machining stainless steel, the base member and the lid member can be accurately manufactured and aligned to within 0.005 millimeter tolerance. Further, for efficient sealing, the underside of the lid member needs to be substantially flat. Again, by machining, flatness can be assured to within 0.005 millimeter tolerance. Although the preferred example machines the lid member from a solid block of stainless steel, it will be appreciated that a stainless steel piece could be cast roughly in the shape of the chamber components (lid member, base member) and then selected surfaces machined as required. Further, it will be appreciated that other materials could be substituted, such as aluminum, Delrin etc. Although the described example uses a lid member formed from a single block, it will be appreciated that the lid member may be constructed from component parts.

In a preferred configuration, each of the base member 100 and the lid member 200 is constructed as a single piece machined from a stainless steel block. Stainless steel is a preferred material as not only does stainless steel have superior sterilization characteristics, but stainless steel is also a heavy material. By constructing the lid member 200 from a heavy material, sufficient gravitational forces act to compress the lid member towards the membrane frame slide (specimen plate) 300 containing the specimen 400. In such a manner the lid member is sufficiently compressed to the base member to create a seal that provides a barrier against contamination and evaporation. The lid member can be weighted using other means, such as adding weights to the lid member, or constructing the lid member from an alternate heavy material. Preferably the lid member weighs between about 10 grams and about 50 grams. Most preferably, the lid member weighs about 25 grams. Preferably the base member weighs between about 10 grams and about 50 grams. Most preferably, the base member weighs about 23 grams. It will be appreciated that the disclosed weight ranges are for a standard size chamber suitable for time-lapse analysis on a Veritas LCM platform. Other weights may be used for other size chambers and other compliant platforms. Further, some applications may not require such complete sealing and may sufficiently seal with less weight.

Optionally, the base member 100 and/or the lid member 200 may include a bar code positioned at one or more ends. The indicia on the bar code identify the particular specimen chamber, and each bar code may have indicia that facilitate identifying which end of the chamber is being scanned. Therefore, an automated machine can read the bar code when a front end or a rear end of the chamber is being inserted into the machine. If both the lid member and the base member have bar codes, then the imaging system can assure that the chamber is positioned in the same orientation on the imaging apparatus.

It is contemplated that the chambers of the present invention are particularly suited for time-lapse analysis on a Veritas LCM platform. Embodiments of the invention particularly suitable for such applications are shown in FIG. 3 (base, i.e. base member 100), and in FIG. 4 (lid, i.e. lid member 200). When the device is intended to be used on the Veritas platform, the preferred dimensions of the base (i.e., base member 100) of the device are as follows: AA=about 93.4 mm; BB=about 35.5 mm; CC=about 86.4 mm; DD=about 62.4 mm; EE=about 5 mm; FF=about 5 mm; GG=about 9 mm; II=about 19.5 mm; JJ=about 5.4 mm; KK=about 5.4 mm; LL=about 15.5 mm; MM=about 2 mm; NN=about 3 mm; OO=about 3 mm; PP=about 5 mm; QQ=about 5 mm; RR=about 12 mm; SS=about 26.3 mm; TT=about 21 mm; UU=about 3.4 mm; VV=about 4.6 mm; WW=about 7 mm; XX=about 3 mm; YY=about 4.6 mm; ZZ=about 4.6 mm; AB=about 4 mm; AC=about 2 mm; AD=about 0.4 mm; AE=about 0.4 mm; AF=about 0.4 mm; AG=about 1 mm; AH=about 25.5 mm; AJ=about 15 mm (FIG. 3). When the device is intended to be used on the Veritas platform, the preferred dimensions of the lid (i.e., lid member 200) of device are as follows: A=about 95.5 mm; B=about 37.5 mm; C=about 12 mm; D=about 6 mm; E=about 8 mm; F=about 3 mm; G=about 76.5 mm; H=about 65.5 mm; I=about 7 mm; J=about 25.5 mm; K=about 19.5 mm; L=about 3 mm; M=about 3 mm; N=about 19 mm; O=about 9 mm; P=about 9 mm; Q=about 9 mm; R=about 1 mm; S=about 2 mm; T=about 0.4 mm; U=about 1 mm; V=about 0.6 mm; W=about 7 mm; X=about 1 mm; Y=about 1 mm; Z=about 1 mm (FIG. 4). A chamber with these, or equivalent, dimensions, is thus capable of accommodating a membrane frame slide for live cells that is distributed by Molecular Devices (e.g. part number LCM0530) or similar type of LCM compatible slide.

When the custom made chamber is designed for a specific system, it is preferably designed to be compatible with the system's optics for visualization and imaging of the entire frame slide, which can contain 2D or 3D cell cultures. For example, with the Veritas LCM system, the chamber is designed so that it can accommodate the LCM membrane frame slide containing the live culture overlaid with media in accordance with the spatial dimensions and working distances of the objectives of the Veritas LCM system. In this example, the method capitalizes on factory-installed features of the LCM system including a motorized stage and software capabilities for image acquisition at various magnifications (in bright field or fluorescent mode) by automated positioning of the slide in X and Y directions and sequential image acquisition at mosaic patterns of field of view at manually selected Z focal planes. The custom-made chamber in combination with the above features enables time-lapse image acquisition with good resolution on the Veritas LCM platform. The culture slides, normally maintained in a cell culture incubator, can be placed in the chamber before imaging. The chamber offers airtight seal to protect the culture from contamination during imaging. Images of the live culture can be acquired at different magnifications, e.g. at 2×, 10× and 20× magnifications at mosaic patterns following standard functions of the Veritas software and the built-in motorized stage of the system. The entire area of the specimen slide (culture area and metallic frame) can be readily imaged while regions of interest can be revisited for time-lapse imaging by saving the coordinates of the several ROIs utilizing standard functions of the Veritas software. In addition, strategically positioned marks on the metallic frame of the specimen slide can facilitate image registration for time-lapse analysis.

The present invention provides methods for characterizing morphologically distinct cell sub-populations in living 2D or 3D cultures targeted for laser capture microdissection (LCM). Heterogeneous cell-populations emerge in culture under factor-induced directed differentiation of stem or progenitor cells or under spontaneous differentiation (as is the case of vasculogenic mimicry). Deciphering the molecular mechanisms of such phenomena is of practical interest in developmental studies and tissue engineering applications. The custom-made chamber of the present invention enables time-lapse topography and pre-selection of desired regions in order to minimize microdissection time. This has many benefits, including optimizing the quality of biomolecules for downstream analyses (Demou, 2008, Biotech & Bioeng. 101: 307-316). The methods are compatible with standard genomics and proteomics assays such as microarrays, real-time PCR and 2D gel electrophoresis. The methods are generally applicable to studying phenotypically evolving 2D or 3D cultures under spontaneous or induced differentiation (e.g. of stem cells) when the goal is isolation of select LCM targets at user-defined end-points for genomics or proteomics. The methods are widely applicable for microgenomics and microproteomics in phenotypically evolving 3D cultures, under spontaneous or directed differentiation. The methods provide a practical discovery engine for a range of developmental studies and tissue regenerative engineering applications. For example, the methods of the present invention can be employed in tandem to study the dynamics of in vitro vasculogenic mimicry.

In one embodiment, time-lapse imaging of living cultures (e.g., cells) according to the present invention requires: (1) a platform/chamber to house the cells during imaging, which should: (i) support cell viability (i.e., enable contact with culture media and protect against contamination) while (ii) being compatible with the imaging process; (2) appropriate imaging hardware, such as a microscope with motorized stage and image acquisition hardware; and (3) computer/software for image acquisition and hardware control.

When LCM of the culture is the ultimate goal, using the custom chamber has one or more of the following major advantages: (i) it allows characterization and monitoring of a cell culture targeted for LCM over several days, on the same platform that will be ultimately used for feature selection and their microdissection; (ii) further investment into an independent time-lapse setup is not necessary since the custom made chamber can exploit the built-in capabilities of the LCM instrument; (iii) the locations of areas (e.g. cell sub-populations) of interest can be marked and easily revisited over time for time-lapse imaging and finally for LCM; (iv) the chamber enables monitoring of the live culture and pre-selection of targets while the cells are maintained in their culture media. Then one can remove the slide that contains the culture from the chamber and proceed with LCM. This significantly minimizes the time that is normally required for culture surveillance and selection of targets during which the live cells would remain (without media) in the LCM system. This minimizes the stress that is inevitably imposed on live cells during LCM, which ultimately enhances significantly the quality of the microdissected samples. For example, utilizing the methods of the present invention, microdissection can be performed within 10-15 min from the moment a slide is inserted into the LCM instrument to the removal of the collection cap containing the microdissected cells. The quality of biomolecules (RNA especially) is known to decay with the time a specimen is in fixed state preceding LCM, which negatively impacts the results of the downstream analyses. Using the devices and the methods of the present invention, microdissection of live cells provides biomolecules of improved quality. Moreover, the methods presented here improve the integrity of the isolated biomolecules.

In some embodiments, the methods of the present invention provide for improved characterization of phenotypic heterogeneities. These heterogeneities can emerge under directed or spontaneous differentiation of stem cells or stem-like cells. Burgeoning approaches in the fields of tissue engineering and organ development capitalize on factor-induced cell differentiation and could benefit from methodologies that enable molecular analysis of the cell sub-populations. The methods of the present invention provide a procedure for characterizing dynamic 3D in vitro cell cultures targeted for LCM. Specifically, the procedure may include: (i) time-lapse imaging and quantification of morphological heterogeneities; (ii) determination of the end-points of the study based on the phenotypical features of the cell sub-populations; (iii) LCM for their specific isolation; and (iv) validation of the method's compatibility with standard genomics and proteomics assays such as gene microarrays, real-time PCR and 2D gel electrophoresis.

### EXAMPLES

It is to be understood that this invention is not limited to the particular methodology, protocols, subjects, or reagents described, and as such may vary. It is also to be understood that the terminology used herein is for the purpose of describing particular embodiments only, and is not intended to limit the scope of the present invention, which is limited only by the claims. The following examples are offered to illustrate, but not to limit the claimed invention.

Cell Culture and 3D Cell-Populated Matrices

Human uveal melanoma cells MUM2B were cultured in RPMI 1640 media (Invitrogen, Carlsbad, Calif.) supplemented with 10% fetal bovine serum and 0.05% gentamicin sulfate (both from Gemini Bio-Products, West Sacramento, Calif.) in a humidified-5% CO₂ atmosphere incubator. Cell-populated 3D constructs were formed in the hollow space of the LCM PEN-membrane frame slides (Molecular Devices Corp.—MDS Inc., Mississauga, Ontario, Canada) as previously described (Demou and Hendrix, 2008, J. Cell. Biochem. 105: 562-573). Briefly, in this example frame slides were standard size metallic slides (1 mm thick) with a rectangular cut, measuring 17×45 mm, through the entire thickness of the slide. Porous polyethylene naphthalate (PEN) membrane was glued on one side of the slide generating a hollow space (measuring 17 mm×45 mm×1 mm) with a membrane base. Collagen gels were formed in this space with 350 μl/slide neutralized rat-tail collagen type-I solution (1 mg/ml) (BD Biosciences, San Jose, Calif.). Cells were seeded on top of the gels at a density of about 650 cells/mm², by overlaying 1 ml cell suspension in complete media.

Custom-Made Time-Lapse Chamber

Several variations of a custom made chamber (FIGS. 1-4) were designed to accommodate the LCM frame slide containing the live culture overlaid with media in accordance with the spatial dimensions and working distances of the objectives of the Veritas LCM system. The culture slides, normally maintained in Petri dishes in a cell culture incubator, were placed in the chamber before imaging. The base member and lid member parts of the chamber, sandwiching a thin gasket of parafilm, were designed to fit tightly. Therefore the chamber offered airtight seal to protect the culture from contamination during imaging. Images of the live culture can be acquired at 2×, 10× and 20× magnifications at mosaic XY patterns following standard functions of the Veritas software and the built-in motorized stage of the system. The Veritas LCM instrument is equipped with a holder that locks a specimen (i.e. individual slide or the chamber) on its motorized stage. By design, a slide loaded in the chamber is orthogonal to both the chamber and the stage. Therefore a consistent orientation of the specimen with respect to the stage is achieved. The entire area of the frame slide (culture area and metallic frame) is readily accessible for imaging. If desired, the metallic frame can be marked at one or more places, to facilitate image registration. Most importantly, the relative coordinates of various groups of regions of interest (ROIs) across the slide can be saved via standard functions of the Veritas software and subsequently revisited for time-lapse imaging or LCM.

Time-Lapse Imaging and LCM of Live Cell Cultures on the Same Platform

Time-lapse imaging was performed using the Veritas LCM system (Molecular Devices). The Veritas system combines: a microscope (typically using 2×, 10×, 20× objectives) for visualizing and positioning the sample and selecting areas of interest; an ultraviolet (UV) laser for cutting around the perimeter of areas of interest; and an infrared (IR) laser that locally attaches the microdissected areas onto a removable collection cap (MacroCap™, Molecular Devices Corp.). The system also has a motorized XYZ stage and automated image acquisition at the XY plane at user-defined focal planes through standard functions of the Veritas software. These features can be utilized for time-lapse image acquisition of the live cultures assuming that there is provided a means of maintaining the 3D cell culture alive and compatible with the image acquisition process over a period of time (e.g. several hours, days, weeks).

Image Analysis and Feature Extraction

High resolution images acquired at the Veritas platform can be exported and analyzed on standard image analysis platforms such as the NIH ImageJ software (National Institutes of Health). In this example, images of the melanoma cultures were acquired every two days during a three-week culture period. The images were analyzed to extract the distributions of the network lengths, widths and total network coverage using the procedure described below. First, the images were thresholded manually to specifically select for network structures. The quality and resolution of the images allowed reliable and exclusive thresholding of the networks without the need of image filtering.

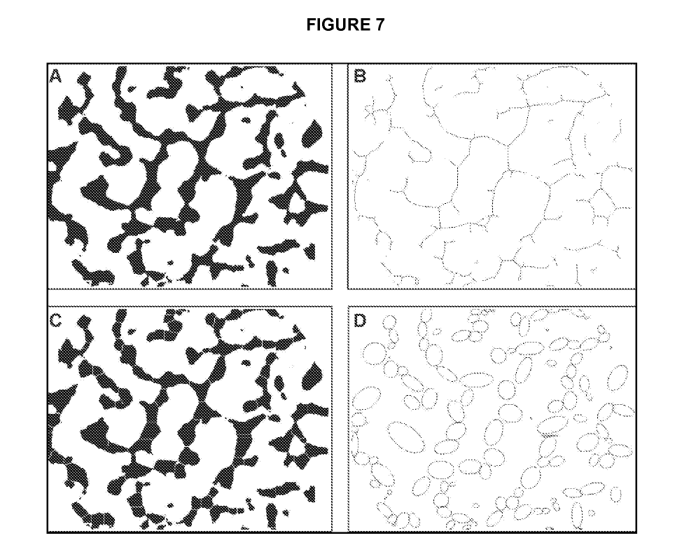

Following binarization of the images the network structures were highlighted black in a white background, which represented the nest areas of randomly oriented cells. The percent area of a field-of-view covered by vascular-like formations versus areas of randomly oriented cells (nests) was quantified by the corresponding black vs. white pixel counts in the binarized image. The “skeletonize” function of ImageJ was applied to the binarized image and the distribution of the corresponding lengths was measured. The watershed filter (standard in ImageJ) was applied to the binarized image to create segments across the networks. The “fit ellipse” command was then applied to the segments. The minor axis of the fitted ellipses was proven a good estimator of the local network width. Thus fitting ellipses to the watershed segmentation of the networks generates a distribution of the network widths in the analyzed field of view. Typical image analysis results are shown in FIG. 7.

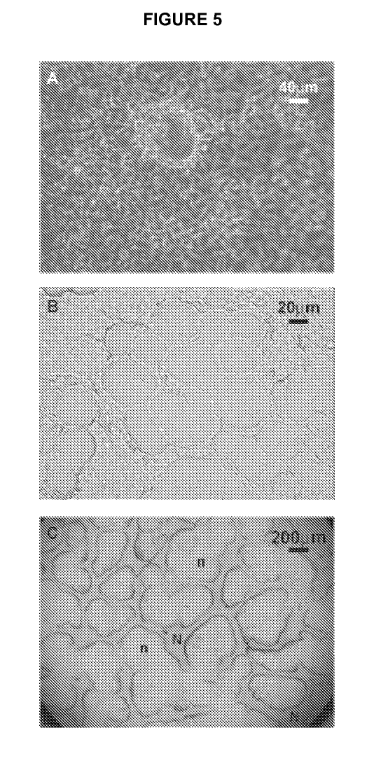

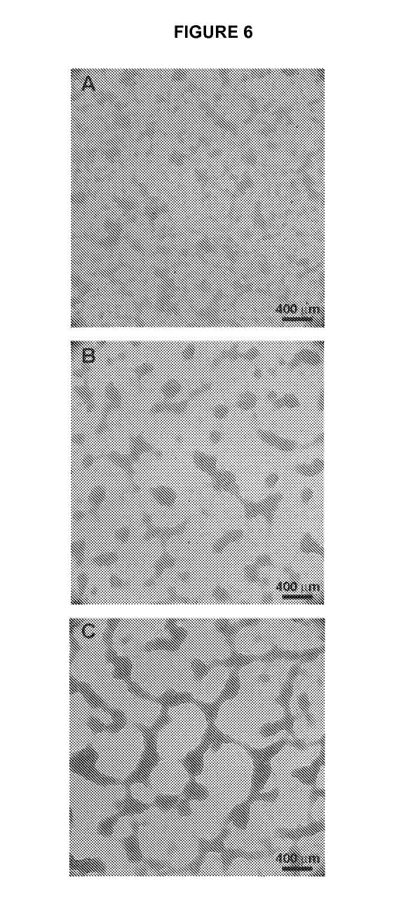

The vasculogenic-mimicry phenotype emerges spontaneously in MUM2B melanoma cells cultured on collagen type-I gels. FIG. 5 shows images of MUM2B aggressive melanoma cells cultured on 3D collagen type-I gels at different stages of vasculogenic mimicry formation. These cells spontaneously differentiated in vascular vessel-like structures. During the first couple of days post-seeding the cultures appeared phenotypically homogeneous composed of randomly oriented cells. By day 4, the first signs of cell-alignment were evident under microscopic examination including linear, circular, or honeycomb patterns (FIG. 5A, B). Over time the cells invaded and remodeled the collagen matrix forming distinct vascular-like networks and nests of randomly oriented cells (FIG. 5C). In FIG. 5(C), 15 days post seeding, fully formed vascular-like networks (N) and nests of randomly oriented cells (n) were established across the culture. In the period between days 14 and 20 post-seeding, the cultures contain vascular-like structures at their peak of maximum width and length before they start losing cohesion. The molecular mechanisms underlying this process remain unknown however a characterization of the cell-subpopulations over time, using the devices and methods of the present invention, is the first step in deciphering the dynamics of this phenomenon. Examples of this are illustrated in FIG. 6, which shows the time-lapse evolution of vasculogenic mimicry networks of MUM2B melanoma cells on collagen type-I gels (bright field optics). FIG. 6(A) shows initial formations of vasculogenic mimicry networks (6 days post-seeding). FIG. 6(B) shows early stages of vasculogenic mimicry (9 days post-seeding). FIG. 6(C) shows mature vasculogenic mimicry structures (14 days post-seeding).

The term “maturation” is used herein to describe increasing morphological similarity of the melanoma networks to blood vessels. “Mature state” signifies a structure that is structurally at its peak based on its vessel-like morphology (as seen in FIGS. 5C and 6C) and before starting to disintegrate after long time in culture. On the other hand “early state” indicates vessel-like structures that are still expanding (in length or width) or appear incomplete compared to morphologies of ultimate differentiation (peak morphology) that are by experience expected from the particular melanoma cell line (as shown in FIG. 6 panels A and B compared to C). To eliminate bias in visual classification, the extent to which a cell culture engages in the formation of vasculogenic mimicry at a given time-point was measured.

FIG. 7 shows image analysis for quantification of the extent of vasculogenic mimicry in 3D cultures of melanoma cells. FIG. 7 exemplifies the process using the panel (C) of FIG. 3 for the following operations: (A) threshold application and binarization of the image; (B) skeletonization of the network structures for measuring the distribution of their lengths; (C) watershed segmentation of the networks; (D) fitted ellipses on the watershed segments for estimating the distribution of network widths across the region of interest. Thus, FIG. 7 summarizes the image analysis procedure for quantifying the extent of vasculogenic mimicry on the basis of 3 parameters: (a) the area covered by vascular-like network structures (as opposed to the area occupied by randomly oriented cells) in a field of interest (FIG. 7A); (b) the distribution of the length of the network structures (FIG. 7B), and (c) the distribution of widths of the networks measured as the minor axis of the ellipses (FIG. 7D) fitted on the fragments created after application of the watershed filter in the binarized images (FIG. 7C). The above parameters are inter-dependent variables and collectively reflect the extent to which a culture is engaging in vasculogenic mimicry formation and the degree of maturation of the vessel-like structures.

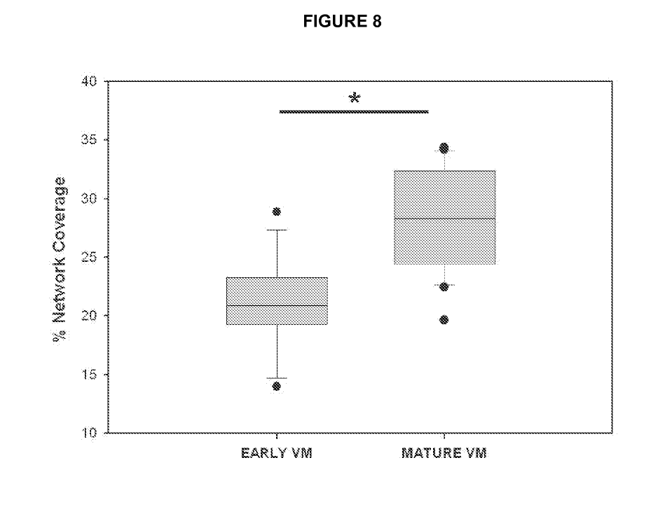

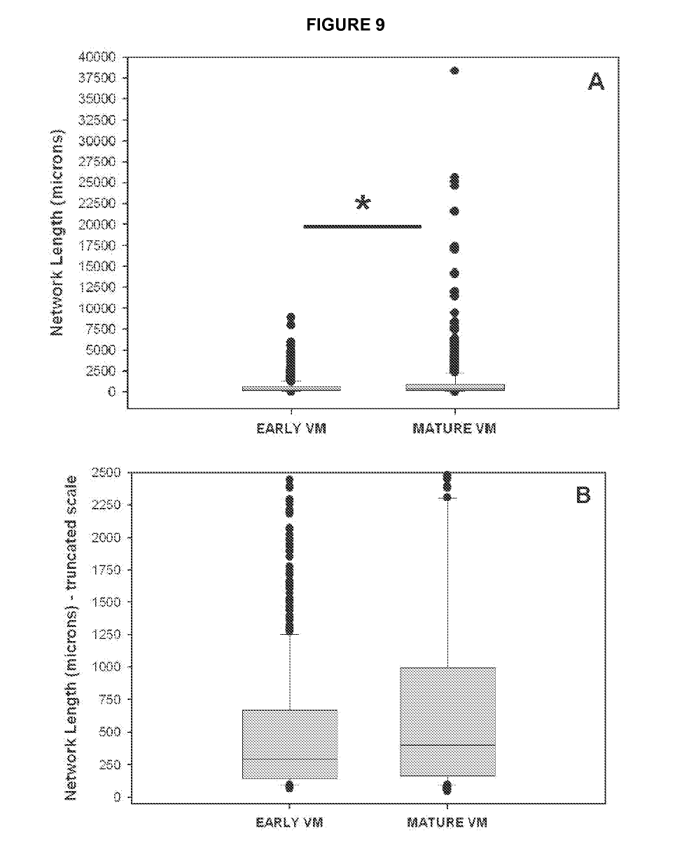

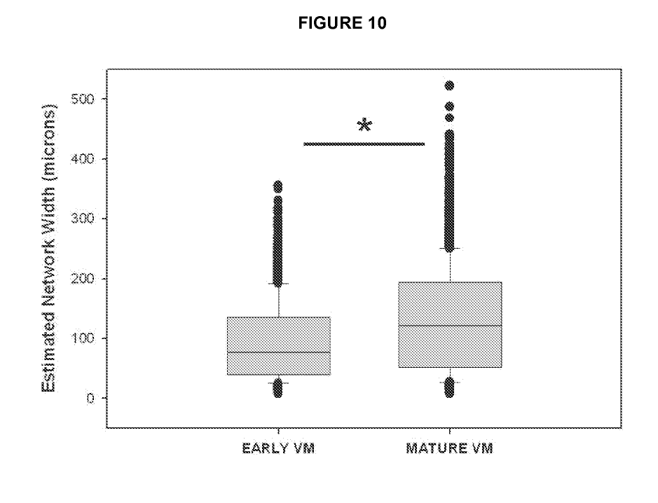

The distributions of vasculogenic mimicry vessel coverage, length, and width are shown in FIGS. 8, 9, and 10, respectively. FIG. 8 is a boxplot showing the distribution of network coverage (area covered by vessel-like structures) per analyzed field of view (each 16.5 mm²) for early and mature states of vasculogenic mimicry. FIG. 9(A) is a boxplot showing the distribution of network lengths for early and mature states of vasculogenic mimicry. FIG. 9(B) shows a truncated scale of the distribution in panel (A) for better visualization of the median, 10th, 25th, 75th, 90th percentiles. FIG. 10 is a boxplot showing the distribution of estimated network widths for early and mature states of vasculogenic mimicry.

Images from cultures 10-16 days post-seeding were analyzed for extraction of morphological features of early stage vasculogenic mimicry networks. Morphological features of mature networks were extracted from cultures 13-18 days post-seeding. For each case, network coverage, length, and width measurements were extracted via analysis of 3 fields of view (19.6 mm²) per gel acquired from 10 independent melanoma cultures. Generally, different degrees of maturation span a melanoma culture. At a random day between days 13 to 20 post-seeding melanoma cultures on collagen gels can contain areas of “early” or “mature” vasculogenic mimicry. Moreover, differentiation can vary locally resulting to contiguous formations of early and mature vasculogenic mimicry networks. These phenomena highlight the importance of characterizing the vasculogenic mimicry locally before LCM followed by genomics and proteomics rather than merely proceed to downstream molecular analyses based on the number of days the cells are in culture on the gel.

Gene Expression Analysis

Total RNA purification, quality testing and quantification were performed. Total RNA was purified from the microdissected samples using the PicoPure kit (Molecular Devices Corp.) as described by Demou and Hendrix, 2008. Quantity and quality of total RNA was measured in the samples using three independent methods: (i) the sample assessment protocol of the Paradise Reagent System (Molecular Devices Corp.), which is a quantitative real-time PCR method that measures the average length of β-actin cDNA by quantification of the PCR product yield ratio of a 3′ end-specific compared to a 5′-specific sequence target (3′/5′ ratio of 1 corresponds to good quality RNA); (ii) the 2100 Bioanalyzer-Pico Chip (Agilent Technologies, Santa Clara, Calif.); and (iii) the Nanodrop spectrophotometer ND-1000 (Nanodrop Technologies, Wilmington, Del.).

Real-Time Polymerase Chain Reaction

Expression of integrin alpha3 (ITGA3), cMET, keratin 8, laminin 5 γ2 chain, and vascular-endothelial cadherin (VE-cad) was quantified with real time PCR utilizing the Taqman technology and the AB7500 Fast Real-Time PCR System (Applied Biosystems, Foster City, Calif.), starting with 150 ng DNase-treated total RNA. C_{T} values were extracted with the SDS software (Applied Biosystems) and analysis based on the ΔΔC_{T} method, using the expression of GAPDH as control.

Gene Oligo Microarrays and Real-Time PCR Arrays

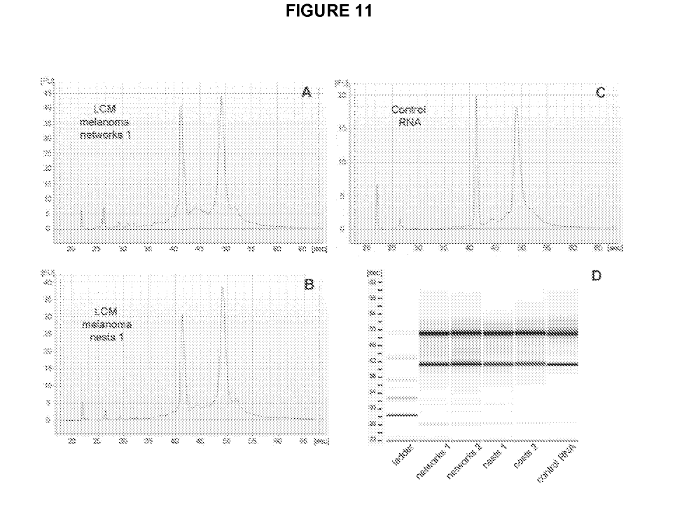

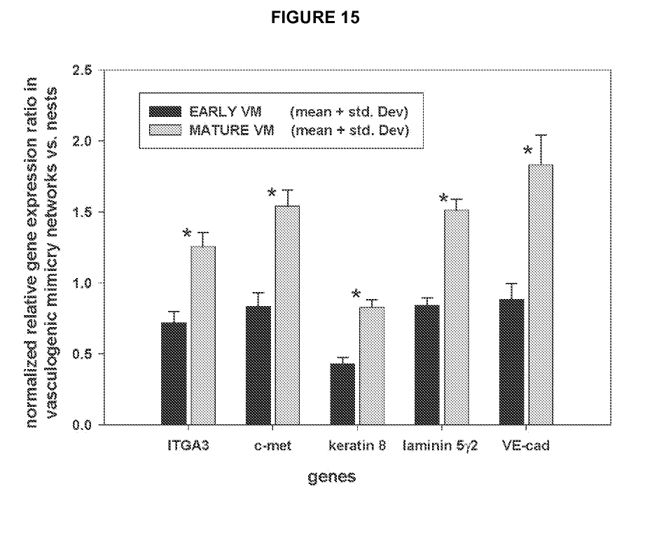

Compatibility with microgenomics analyses was demonstrated with the human gene oligo microarrays and RT² Profiler PCR arrays (SuperArray, Frederick, Md.) specific to Human Angiogenesis starting with 200 ng purified total RNA according to manufacturer's instructions, as described in detail in Demou and Hendrix, 2008, J. Cell. Biochem. 105: 562-573. FIG. 11 shows typical bioanalyzer electropherograms for RNA samples purified from melanoma cells in laser capture microdissected networks (A) and nests (B) compared to control RNA (C). FIG. 11(D) shows the corresponding RNA gel-view for (A-C). FIG. 15 shows data from real-time PCR gene expression analysis for select genes in melanoma networks versus surrounding randomly oriented cells. The data show how the levels of differential gene expression increase as the networks mature.

2D-Gel Protein Analysis

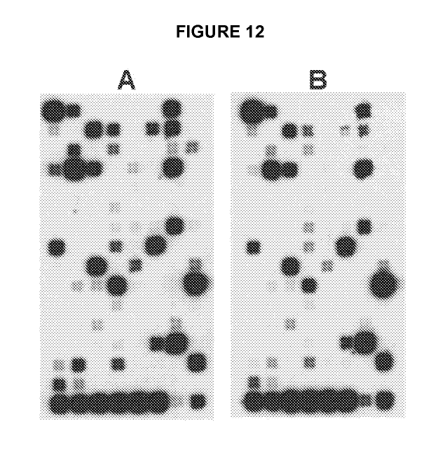

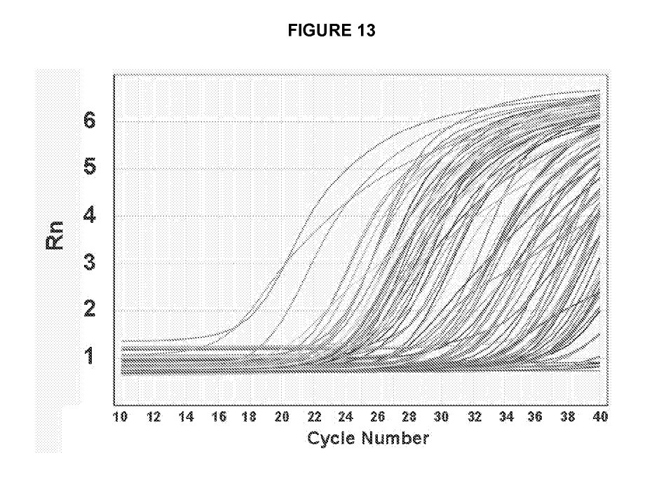

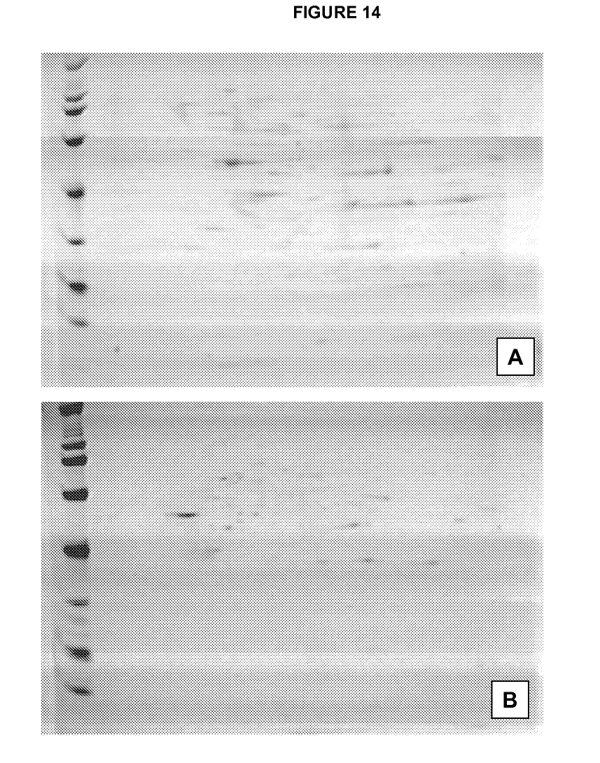

For protein analysis, the microdissected samples were extracted with urea-thiourea buffer. The samples were then loaded on 2D gels utilizing the ZOOM IPG Runner strip system (Invitrogen) for the first dimension isoelectric focusing followed by 2D gel electrophoresis in the NuPAGE Bis-Tris 4-12% ZOOM gels (Invitrogen) according to manufacturer's protocol with a 1:1 mixture of low and high molecular weight standards loaded for reference. The gels were stained with the SYPRO Ruby Protein Gel Stain overnight (Invitrogen—Molecular Probes) to allow visualization and image acquisition under UV light. FIGS. 12-15 show examples of post-LCM downstream applications in genomics and proteomics. FIG. 12 shows gene microarray profiling of 128 angiogenesis-specific genes in “mature” networks (A) and randomly oriented (nests) (B) of MUM2B melanoma cell. FIG. 13 shows data from real-time PCR array for profiling in parallel 96 angiogenesis-specific genes from microdissected “mature” MUM2B melanoma networks. FIG. 14 shows data from 2D gel electrophoresis for MUM2B cells in microdissected “mature” networks (A) and nests (B).

Data Analysis

The distributions of network area coverage, length, and width are presented as boxplots with marked median, 10^{th}, 25^{th}, 75^{th}, 90^{th} percentiles. The one-way ANOVA test (SigmaStat v.3.11 software, Systat Software, San Jose, Calif.) was used for statistical group comparisons and significant differences (marked with “*”) correspond to P-values<0.05.

As demonstrated herein, compatibility of cells isolated through LCM from living cell-populated 3D matrices with standard downstream genomic and proteomics analyses was tested and successfully confirmed. The technique yielded total RNA of excellent quality verified by three independent methods. The PCR product yield ratio corresponding to sequences specific to the 3′ vs. 5′ end of β-actin cDNA, consistently giving values of practically 1. Specifically, statistics on the PCR method ratio for 10 independent RNA samples from microdissected melanoma cells in networks and nests yielded 0.98±0.06 (mean±STD). Similarly, statistics performed on the nanodrop spectrophotometer readings for the values of the A₂₆₀/A₂₈₀ ratio for 10 independent network or nest RNA samples gave 2.4±0.37 (mean±STD). Normally, an A₂₆₀/A₂₈₀ ratio between 2.0-2.6 indicates very pure, good quality RNA. Moreover, typical bioanalyzer electropherograms for RNA from microdissected networks and nests are presented in FIG. 8 and further confirm the excellent RNA quality.

Compatibility with microgenomics has been addressed previously (Demou and Hendrix, 2008, J. Cell. Biochem. 105: 562-573) by microdissecting uveal and cutaneous melanoma cells from collagen type-I gels and Matrigel. Typical microarray blots (FIG. 9A-B) and a real-time PCR amplification plot for 96 genes assayed in parallel (real-time PCR array) (FIG. 9A-C) are shown. Similar analyses revealed previously the strong endogenous angiogenic capabilities of the vasculogenic mimicry networks (Demou and Hendrix, 2008, J. Cell. Biochem. 105: 562-573). Compatibility with proteomics was herein demonstrated with 2D gel electrophoresis for the total protein content of mature vasculogenic mimicry networks and neighboring nests microdissected (with LCM) from collagen type-I gels. FIG. 9D-E show pictures of blots representing networks and nests. Differences in proteins are easily discernable. These spots can be excised and are compatible with mass spectrometry analysis (i.e. tandem MS).

It is to be understood that this invention is not limited to the particular devices, methodology, protocols, subjects, or reagents described, and as such may vary. It is also to be understood that the terminology used herein is for the purpose of describing particular embodiments only, and is not intended to limit the scope of the present invention, which is limited only by the claims. Other suitable modifications and adaptations of a variety of conditions and parameters, obvious to those skilled in the art of bioengineering, biochemistry, molecular biology, microscopy, and imaging, are within the scope of this invention. All publications, patents, and patent applications cited herein are incorporated by reference in their entirety for all purposes.

What is claimed is:

1. A chamber, comprising:
a) a base member which defines a recessed area dimensioned to receive a membrane frame slide, the base member defining a perimeter portion, the base member further defining a transparent portion dimensioned for viewing biological material on the membrane frame slide; and
b) a lid member which is dimensioned to at least substantially overlay the base member when the lid member is closed, the lid member defining a perimeter portion, the lid member further defining a transparent portion dimensioned for viewing biological material on the membrane frame slide,
wherein the chamber is dimensioned so that the biological material can be imaged by time-lapse imaging and the chamber is configured for use with laser capture microdissection.

2. The chamber of claim 1 further comprising a perimeter seal to facilitate sealing between the base member and the lid member.

3. The chamber of claim 1 wherein the base member further defines a slot extending outwardly from the recessed area, the slot substantially parallel to the membrane frame slide, the slot configured for releasably removing the membrane frame slide from the chamber, when the chamber is open.

4. The chamber of claim 1 wherein the transparent portion of the base member comprises glass.

5. The chamber of claim 1 wherein the perimeter portion of the base member comprises stainless steel.

6. The chamber of claim 1 wherein the transparent portion of the lid member comprises glass.

7. The chamber of claim 1 wherein the perimeter portion of the lid member comprises stainless steel.

8. The chamber of claim 1 further comprising a lid member latch to fix the lid member in a closed position over the base member.

9. The chamber of claim 1, which is designed for use in conjunction with a Veritas laser capture microdissection system.

10. A chamber for holding specimen slides, the chamber comprising:
a) a base member comprising a perimeter portion and a transparent portion, the base member sized to permit insertion of a specimen slide; and
b) a lid member comprising a perimeter portion and a transparent portion, the lid member with a top and bottom surface, wherein the bottom surface overlays the specimen slide space in the chamber when the lid member is closed,
wherein the chamber is configured and dimensioned so that the specimen can be imaged by time-lapse imaging and analyzed using laser capture microdissection means.

11. The chamber of claim 10 further comprising a seal to facilitate sealing between the base member and the lid member.

12. The chamber of claim 10 wherein the base member further defines a slot extending outwardly from the specimen slide space, the slot substantially parallel to the specimen slide, the slot configured for releasably removing the specimen slide from the chamber, when the chamber is open.

13. The chamber of claim 10 wherein the transparent portion of the base member comprises glass.

14. The chamber of claim 10 wherein the perimeter portion of the base member comprises stainless steel.

15. The chamber of claim 10 wherein the transparent portion of the lid member comprises glass.

16. The chamber of claim 10 wherein the perimeter portion of the lid member comprises stainless steel.

17. The chamber of claim 10 further comprising a lid member latch to fix the lid member in a closed position over the base member.

18. The chamber of claim 10, which is designed for use in conjunction with a Veritas laser capture microdissection system.

19. A system for the monitoring of specimen targeted for laser capture microdissection, the system comprising
a) a chamber for holding specimen slides, the chamber dimensioned so that the specimen can be imaged by time-lapse imaging and analyzed using laser capture microdissection means, comprising
i. a base member comprising a transparent portion, the base member sized to permit insertion of a specimen slide, and
ii. a lid member comprising a transparent portion, the lid member with a top and bottom surface, wherein the bottom surface overlays the specimen slide space in the chamber housing when the chamber is closed,
b) an apparatus for laser capture microdissection suitable for use in conjunction with the chamber; and
c) software for automated time-lapse imaging of the specimen when the specimen is positioned in the chamber.

20. The system of claim 19 wherein the apparatus for laser capture microdissection is a Veritas laser capture microdissection apparatus.

21. A method for the monitoring of biological material targeted for laser capture microdissection, the method comprising
a) providing a chamber suitable for use in conjunction with a laser capture microdissection apparatus, the chamber comprising
i. a base member which defines a recessed area dimensioned to receive a membrane frame slide, the base member further defining a perimeter portion and a transparent portion dimensioned for viewing biological material on the membrane frame slide; and
ii. a lid member which is dimensioned to overlay the base member when the lid member is closed, the lid member further defining a perimeter portion and a transparent portion dimensioned for viewing biological material on the membrane frame slide,
b) imaging the specimen using time-lapse imaging means, and;
c) subsequently analyzing the specimen using laser capture microdissection means.

22. The method of claim 21 wherein the chamber is designed for use in conjunction with a Veritas laser capture microdissection system.
